(19) United States
(12) Patent Application Publication
(10) Pub. No.: US 2013/0011188 A1
(43) Pub. Date: Jan. 10, 2013

(54) Integrated Plastic Part And Fastener

(76) Inventor: Patrick Brian Donnelly, Brighton, MI (US)

(21) Appl. No.: 13/522,089

(22) PCT Filed: Jan. 9, 2011
(86) PCT No.: PCT/US11/20617

§ 371 Date: Sep. 18, 2012

Related U.S. Application Data
(60) Provisional application No. 61/294,957, filed on Jan. 14, 2010.

(51) Int. Cl. F16B 17/00

(52) U.S. Cl. 403/291

(57) ABSTRACT

A re-usable integrated plastic part (20), such as an automotive plastic trim panel (36) and fastener (22) for attachment to a support member (24), such as a steel frame. The fastener (22) includes a mandrel (26) integral with and extending transversely from the panel (36). A flexible component (30) coupled to the mandrel (26) includes a pair of rivets (32) disposed on opposite sides of the mandrel (26) for engaging the support member (24). The flexible component (30) also includes arms (56) bending at hinge points (62) upon engagement of the support member (24) by the rivets (32). The flexible component (30) includes an intermediate section (34) expanding to an installed intermediate width (wᵢ) to maintain the rivets (32) in wedged engagement between the mandrel (26) and the support member (24).

### CROSS REFERENCE TO RELATED APPLICATION

This U.S. National Stage Patent Application claims priority to International Patent Application Serial No. PCT/US2011/020617 filed on Jan. 9, 2011, entitled “Integrated Plastic Part And Fastener” and U.S. Provisional Application Ser. No. 61/294,957, filed Jan. 14, 2010, entitled “Integrated Plastic Part And Fastener,” the entire disclosures of all of these applications being considered part of the disclosure of this application and are hereby incorporated by reference.

### BACKGROUND OF THE INVENTION

1. Field of the Invention

The present invention relates to fasteners for attaching a plastic part to a support member.

2. Description of the Prior Art

Fasteners for attaching plastic parts to support members are commonly used in the automotive industry. The fastener attaches the plastic part, such as a trim panel, to a support member, such as a steel frame of a passenger seat, door, or another section of the vehicle body. The trim panel may cover a section of the vehicle body and the mechanical parts disposed along the vehicle body. In one example, the trim panel is attached to the steel frame of a passenger seat to cover the electric motor driving the seat recliner. Oftentimes, the trim panel and fastener are removed for servicing the steel frame or parts covered by the trim panel. For example, the trim panel and fastener are removed from the steel frame of the passenger seat to service the electric motor covered by the trim panel.

The fasteners may include a variety of different designs. Many fasteners include a two-piece design, such as a pin and grommet, or a plastic pin with a spring steel “A-clip.” Other fasteners are formed integral with the plastic part. One example of an existing integral fastener comprises a rigid cantilevered arm extending transversely from the trim panel, and a catch extending from the cantilevered arm. The cantilevered arm is inserted into an aperture of the steel support member, and the support member is secured along the cantilevered arm between the catch and the trim panel. The integral fastener provides cost savings on material compared to the two-piece fasteners.

Unfortunately, existing integral fasteners require high installation efforts and are oftentimes damaged during servicing, i.e., removing and re-inserting the fastener into the aperture. The steel support member typically has sharp edges around the aperture, which engage and wear the plastic fastener upon insertion, removal, and re-insertion into the aperture of the steel support member. For example, the cantilevered arm of the existing integral fastener may experience irreversible damage, such as a crack or permanent bend in the horizontal direction. Therefore, the trim panel and integral fastener must be replaced almost every time the integral fastener is removed from the support member.

### SUMMARY OF THE INVENTION

A re-useable integrated plastic part and fastener for attaching to a support member comprises a plastic part formed of a plastic material, a mandrel integral with and extending transversely from the plastic part, and a flexible component integral with and disposed outwardly of the mandrel. The flexible component includes arms having a length extending transversely to the plastic part. The flexible component also has an intermediate section extending between the arms and outwardly of the mandrel and having a width extending parallel to the plastic part. The arms of the flexible component are contractible in the length and the intermediate section is expandable in the width.

During insertion of the integrated fastener into an aperture of the support member, the intermediate section of the flexible component is inserted into the aperture without dragging along the steel support member, which reduces wear and damage to the integrated fastener during insertion. Thus, the integrated plastic part and fastener can be re-used numerous times to provide significant cost savings, compared to other fasteners. The integrated fastener can be inserted, removed, and re-installed (i.e. serviced) about five times before experiencing significant wear or another negative effects on the physical characteristics of the fastener. Upon insertion, the support member is wedged between the arms and the intermediate section of the flexible component so that the integrated plastic part and fastener remains securely disposed in the aperture of the support member. A force greater than a minimum retention force is applied to remove the integrated fastener from the aperture.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a front side view of an integrated plastic part and fastener in an uninstalled position;

FIG. 2 is a back side view of the integrated plastic part and fastener in the uninstalled position;

FIG. 3 is a first perspective view of the integrated plastic part and fastener in the uninstalled position;

FIG. 4 is a second perspective view of the integrated plastic part and fastener in the uninstalled position;

FIG. 5 is a side view of the integrated plastic part and fastener in the uninstalled position; and

FIG. 6 is a front side view of the integrated plastic part and fastener in an installed position.

### DETAILED DESCRIPTION OF THE INVENTION

The subject invention provides a re-useable fastener 22 that is integrated into a plastic part 20, such as a trim panel of an automotive vehicle. The re-useable integrated plastic part 20 and fastener 22 attaches to a support member 24, such as a steel frame of an automotive vehicle. The re-useable integrated plastic part 20 and fastener 22 provides a low insertion force and high retention force. Thus, the integrated plastic part 20 and fastener 22 is suitable for use in “snap on” applications, such as securing automotive interior trim panels to steel frames. The integrated plastic part 20 and fastener 22 can be used in place of other fasteners and plastic parts that must be purchased and installed separately. Further, the integral plastic part 20 and fastener 22 can be removed from the aperture 28 and re-used numerous times, which provides a significant cost savings relative to other fasteners that must be replaced after fewer uses.

The integrated plastic part 20 and fastener 22 includes a mandrel 26 integral with and extending transversely from the plastic part 20. The fastener 22 also includes a flexible component 30 disposed outwardly of the mandrel 26. The flexible component 30 includes pair of arms 56 contractible in length and an intermediate section 34 expandable in width. The arms 56 contract in the length and the intermediate section 34 expands in the width when an insertion force is applied to the fastener 22 while the fastener 22 engages the support member 24 to insert the integral plastic part 20 and fastener 22 into an aperture 28 of the support member 24. The flexible component 30 is inserted and then disposed in wedged engagement between the mandrel 26 and the support member 24, so that the integral plastic part 20 and fastener 22 is secured in place.

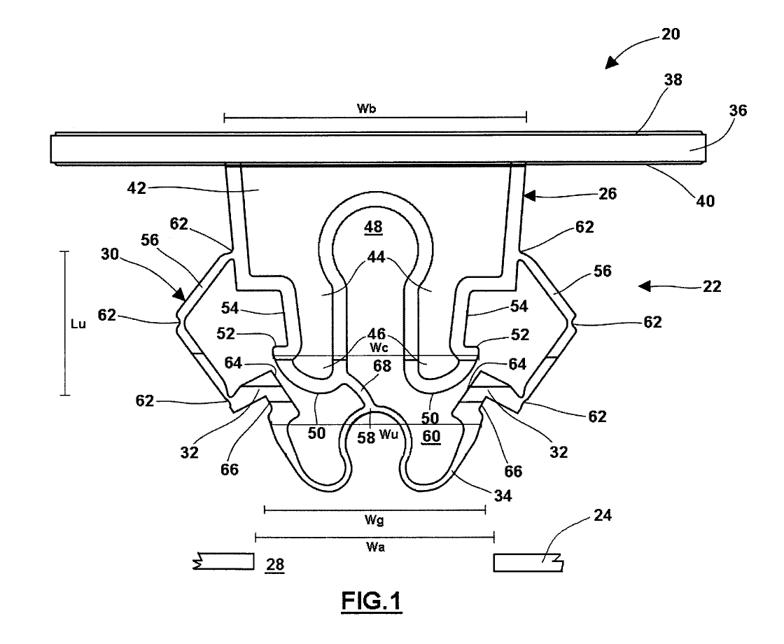

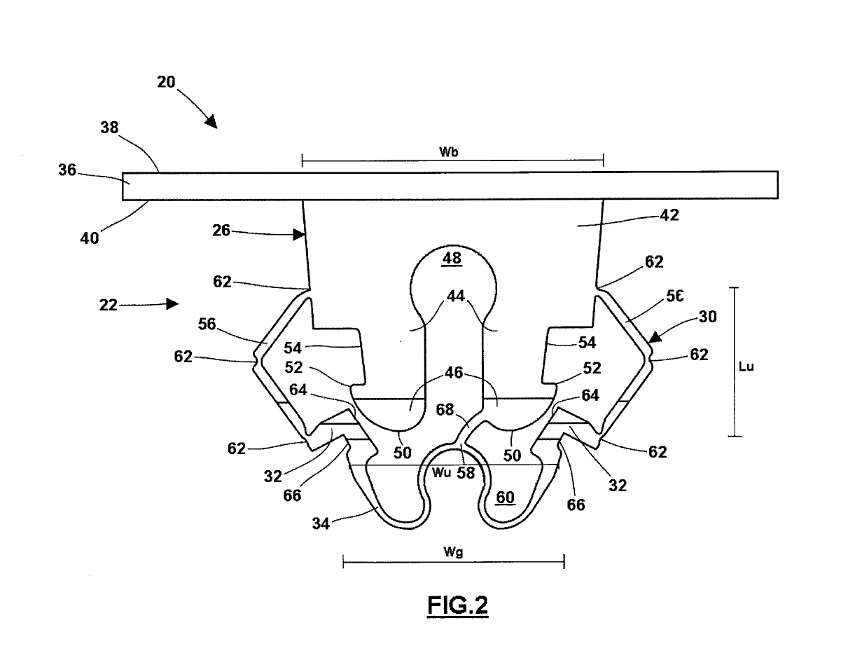

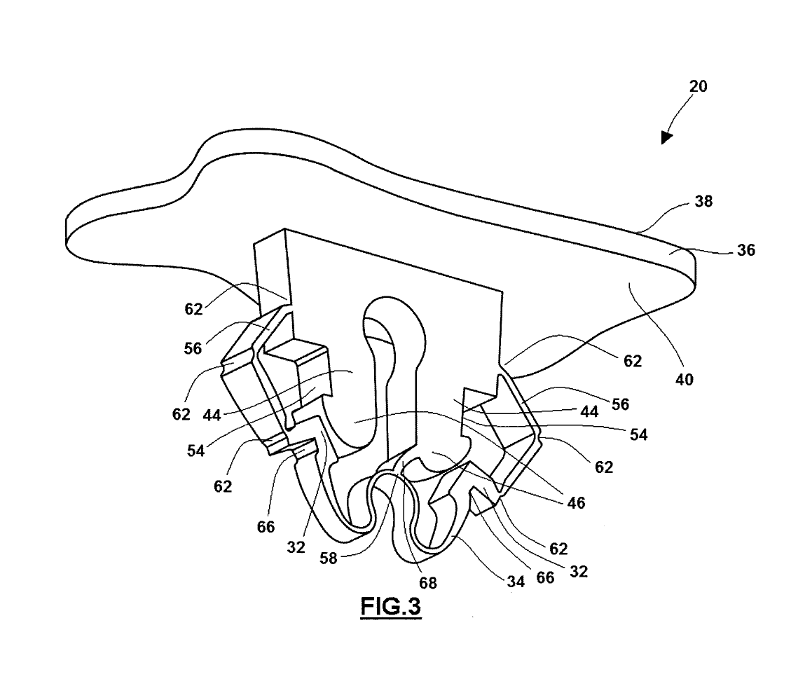

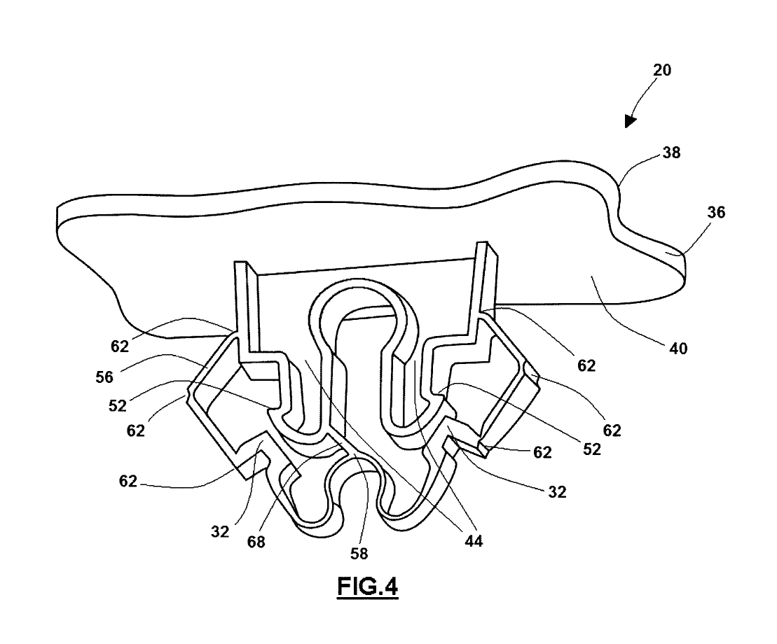

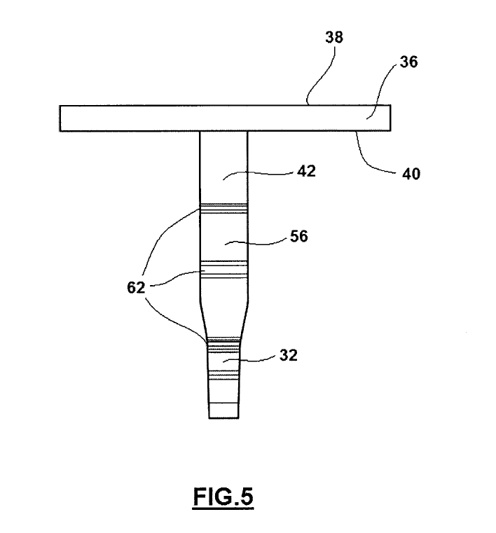

As shown in FIGS. 1-6, the plastic part 20 includes a panel 36 having an exterior surface 38 and an oppositely facing interior surface 40 presenting a planar cross section. As stated above, the panel 36 can be a trim panel, such as side panel of a passenger seat or a door panel of the automotive vehicle, with the exterior surface 38 facing outwardly toward a passenger compartment of the vehicle. The exterior surface 38 may include a variety of colors and patterns. The exterior surface 38 typically includes a smooth surface, as shown in FIGS. 1, 2, 5, and 6. The interior surface 40 of the trim panel 36 faces toward the support member 24. The interior surface 40 also typically includes a smooth surface, as shown in FIGS. 1-6. Although not shown, the interior surface 40 and the exterior surface 38 may include a rough surface or present a non-planar cross section. Further, although the typical application of the plastic part 20 is an automotive interior trim panel for attachment to a support member 24, such as the steel frame, the plastic part 20 can have other applications, including automotive and non-automotive. The plastic part 20 can include a variety of other designs, including planar and non-planar designs.

As stated above and shown in FIGS. 1-4 and 6, the fastener 22 includes the mandrel 26 integral with and extending transversely from the interior surface 40 of the plastic part 20. Preferably, the mandrel 26 extends perpendicular to the interior surface 40 of the plastic part 20. The mandrel 26 includes a base 42 extending transversely from the plastic part 20. The base 42 has a base width w_{b} extending along and parallel to the panel 36 of the plastic part 20. The mandrel 26 also includes at least one shaft 44 extending transversely from the base 42. The shafts 44 have a combined width w_{c} extending parallel to the base width w_{b} and being less than the base width w_{b}. Preferably, the mandrel 26 includes pair of shafts 44 spaced from one another and each extending transversely from the base 42 and from the plastic part 20 to a shaft head 46. The shafts 44 and the base 42 define a keyhole slot 48 therebetween and open at the shaft heads 46, as shown in FIGS. 1-4 and 6. The combined width w_{c} of the pair of shafts 44 and keyhole slot 48 is less than the base width w_{b}, which allows the shafts 44 to be inserted into the aperture 28 of the support member 24 having an aperture width wₐ greater than the combined width w_{c}. The base width w_{b} is greater than the aperture width wₐ so that the base 42 remains disposed on the support member 24 around the aperture 28 after the shafts 44 are inserted into the aperture 28.

In one example embodiment, the aperture width wₐ of the support member 24 is about 22 mm, and the aperture 28 has a length of about 6 mm extending transverse to the aperture width wₐ and into the support member 24. The base width w_{b} is greater than the 22 mm aperture width wₐ and the combined width w_{c} of the shafts 44 is less than the 22 mm aperture width wₐ.

As stated above, each of the shafts 44 extend transversely from the base 42 to a shaft head 46. Each of the shaft heads 46 present a concave surface 50 facing away from the plastic part 20. The shaft heads 46 engage the flexible component 30 as the arms 56 contract in the length and the intermediate section 34 expands in the width. Each of the shaft heads 46 also present a ledge 52 facing and extending parallel to the interior surface 40 of the plastic part 20. The mandrel 26 defines a channel 54 along the shafts 44 between the ledge 52 and the base 42. The channel 54 faces outwardly and away from the keyhole slot 48. Although not shown, the mandrel 26 can include other designs. For example, the mandrel 26 could include a single shaft 44 without the keyhole slot 48, and defining the channels 54 on opposite sides of the shaft 44.

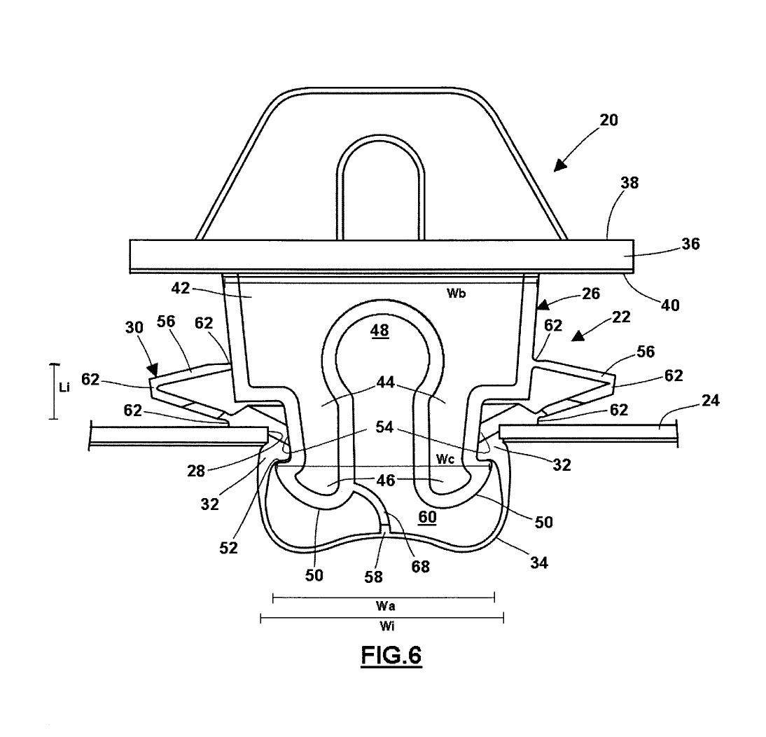

As shown in FIGS. 1-4 and 6, the fastener 22 includes a flexible component 30 coupled to, integral with, and extending outwardly from the mandrel 26. The flexible component 30 preferably includes a pair of arms 56 disposed opposite one another. An end of each arm 56 is attached to the base 42 of the mandrel 26 between the shafts 44 and the panel 36. Each arm 56 of the flexible component 30 has the length extending transverse, preferably perpendicular, to the plastic part 20 and the base width w_{b}. The length of the arms 56 extends from the base 42 and along the shafts 44. The arms 56 are contractible in the length when the flexible component 30 engages the support member 24 while a downward insertion force is applied to the plastic part 20 to insert the fastener 22 into the aperture 28 of the support member 24. The arms 56 contract from an uninstalled arm length Lᵤ before the fastener 22 is inserted into the aperture 28, as shown in FIG. 1, to an installed arm length Lᵢ after the fastener 22 is inserted into the aperture 28, as shown in FIG. 6. The installed arm length Lᵢ is less than the uninstalled arm length Lᵤ. The arms 56 contract toward the plastic part 20 as the fastener 22 is inserted into the aperture 28. Preferably, the fastener 22 includes the pair of arms 56, but can include one or more arms 56.

The arms 56 of the flexible component 30 preferably include a plurality of hinge points 62, i.e. living hinges, which allow the arms 56 of the flexible component 30 to bend upon engagement of the support member 24, as shown in FIG. 6. In the embodiment shown in FIGS. 1-6, the arms 56 include three hinge points 62. Preferably, the hinge points 62 have a thickness that is less than the thickness of the remaining portions of the arms 56, allowing the arms 56 to bend at the hinge points 62 and contract in the length toward the plastic part 20. By contracting at the hinge points 62 toward the plastic part 20, the support member 24 is maintained by the flexible component 30 as the fastener 22 is inserted into the aperture 28. Thus, the sharp edges of the support member 24 do not impact or scratch the fastener 22 as it is inserted into the aperture 28.

As alluded to above and shown in FIGS. 1-6, the flexible component 30 includes a pair of the rivets 32 each disposed between one of the arms 56 and the intermediate section 34 on opposite sides of the mandrel 26. Each rivet 32 is disposed outwardly from the concave surfaces 50 of the shafts 44. Each rivet 32 includes a sliding surface 64 facing toward the mandrel 26. The rivet 32 engages and slides along the concave surface 50 and into the channel 54 of the adjacent shaft 44 of the mandrel 26 as the arms 56 contract in the length and the intermediate section 34 expands in the width. In an installed position, as shown in FIG. 6, each rivet 32 is disposed in the channel 54 of the adjacent shaft 44.

Each rivet 32 defines a groove 66 facing opposite the sliding surface 64 for engaging the support member 24 as the fastener 22 is inserted into the aperture 28. The groove 66 faces outwardly and away from the mandrel 26. In an uninstalled position, as shown in FIGS. 1-5, the grooves 66 of the rivets 32 are spaced from one another by a groove width w_{g}, which is slightly less than the base width w_{b} and the aperture width wₐ so that the rivets 32 are approximately aligned with the sharp side edges around the aperture 28 of the support member 24. In the example embodiment, the groove width w_{g} is about 18 mm to about 20 mm. As alluded to above and shown in FIG. 6, in the installed position, the groove width w_{g} increases as the as the fastener 22 is inserted into the aperture 28. The support member 24 is maintained in the grooves 66 of the rivets 32, and the rivets 32 are disposed in the channel 54 of the shafts 44. The arms 56 have a thickness less than the thickness of the rivets 32. The greater thickness of the rivets 32 provides additional strength to the mandrel 26 and prevents damage by the support member 24.

The flexible component 30 extends from the arms 56 to the rivets 32 and then to the intermediate section 34. The intermediate section 34 extends along and around the shafts 44 to a bottom point 58. The arms 56, rivets 32, and intermediate section 34 of the flexible component 30 are spaced from the shafts 44 to define a space 60 therebetween. The bottom point 58 is disposed below and spaced from the shaft heads 46 and the keyhole slot 48.

The intermediate section 34 is disposed between and interconnects the opposite rivets 32 and arms 56 to one another, as shown in FIGS. 1-4 and 6. The intermediate section 34 is disposed outwardly of the shaft heads 46, such that the shaft heads 46 are disposed between the plastic part 20 and the intermediate section 34. The intermediate section 34 has the width extending parallel to the interior surface 40 of the panel 36 of the plastic part 20.

The intermediate section 34 of the flexible component 30 is expandable in the width when the downward insertion force is applied to the panel 36 while the rivets 32 of the flexible component 30 engage the support member 24. The arms 56 contract in the length and the intermediate section 34 expands in the width simultaneously when the flexible component 30 engages the support member 24 and while an insertion force is applied to the plastic part 20. The intermediate section 34 has a thickness less than the thickness of the rivets 32, allowing the intermediate section 34 to bend and expand in the width.

In the uninstalled position, as shown in FIGS. 1-5, the width of the intermediate section 34 is referred to as an uninstalled intermediate width wᵤ, which is less than the base width w_{b}, less than the aperture width wₐ, and less than the groove width w_{g} so that intermediate section 34 can be inserted into the aperture 28 without engaging the support member 24. The width of the intermediate section 34 expands to an installed intermediate width wᵢ, as shown in FIG. 6, which is greater than the uninstalled intermediate width wᵤ. Also in the installed position, the intermediate section 34 is disposed below the support member 24 and the installed intermediate width wᵢ is slightly greater than the aperture width wₐ to sustain the support member 24 and maintain the rivets 32 in wedged engagement between the channel 54 of the shafts 44 and the support member 24, as shown in FIG. 6. The support member 24 is wedged between the arms 56 and the intermediate section 34 of the flexible component 30.

As shown in FIGS. 1-4 and 6, a truss member 68 interconnects the mandrel 26 and the intermediate section 34 to support the intermediate section 34 as the intermediate section 34 expands in the width. The truss member 68 extends from the shaft head 46 of one of the shafts 44 to the bottom point 58 of the intermediate section 34.

The plastic part 20 and fastener 22 are preferably formed of the same plastic material by an injection molding process. The plastic part 20 and fastener 22, including the mandrel 26 and flexible component 30, are integral and homogeneous. The plastic material preferably includes a non-reinforced flexible plastic, such as polypropylene, nylon, or polycarbonate-acrylonitrile butadiene styrene (PC-ABS). However, the plastic material of the integrated fastener 22 and plastic part 20 is not limited to non-reinforced flexible plastics. Alternatively, the plastic part 20 and faster 22 could include more than one plastic material, which can be formed by an injection molding process. The integrated plastic part 20 and fasteners 22 preferably have a density of about 0.9 g/cm³ to about 1.2 g/cm³ at 23° C.

As stated to above, the integrated plastic part 20 and fastener 22 is inserted into the aperture 28 of the support member 24, which is typically formed of steel. First, the intermediate section 34 travels through the aperture 28, without engaging the support member 24. Next, as the fastener 22 travels through the aperture 28, the grooves 66 of the rivets 32 engage edges of the support member 24 along the aperture 28. Preferably, the rivet 32 is the only part of the integrated fastener 22 that engages the support member 24. The integrated fastener 22 does not drag along the steel support member 24, and thus provides reduced wear and damage to the integrated fastener 22 during insertion and removal, compared to other fasteners. The sliding surface 64 of the rivets 32 slide along the concave surfaces 50 of the shafts heads 46 toward the plastic part 20. As the rivets 32 engage the support member 24 and slide toward the plastic part 20, the intermediate section 34 begins to expand in the width from the uninstalled intermediate width wᵤ to the installed intermediate width wᵢ. While the intermediate section 34 expands, the arms 56 of the flexible component 30 simultaneously contract in the length toward the plastic part 20, from the uninstalled arm length Lᵤ to the installed arm length Lᵢ. As the fastener 22 travels further into the aperture 28, the intermediate section 34 expands further, the arms 56 contract further, and the rivets 32 slide further toward the plastic part 20 and into the channel 54 of the shafts 44. The intermediate section 34 finally reaches the installed intermediate width wᵢ, which is slightly greater than the aperture width wₐ, to maintain the rivets 32 in wedged engagement between the channel 54 of the shafts 44 and the support member 24, as shown in FIG. 6. The integrated plastic part 20 and fastener 22 has a high retention force. The integrated plastic part 20 and fastener 22 is removed from the aperture 28 by applying a minimum retention force to the integrated plastic part 20 and fastener 22. The fastener 22 is secured in the aperture 28 of the support member 24, unless a force greater than the minimum retention force is applied to the fastener 22. In the example embodiment, the minimum retention force is about 10 pounds.

As stated above, during insertion and removal of the integrated plastic part 20 and plastic fastener 22, the integrated fastener 22 does not drag along the steel support member 24, which reduces wear and damage to the integrated fastener 22. The integrated fastener 22 can be inserted, removed, and re-installed (i.e. serviced) about five times before experiencing significant wear or other negative effects on the physical characteristics of the fastener 22, which provides significant cost savings, compared to the fasteners 22 of the prior art.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. A re-useable integrated plastic part and fastener for attaching to a support member, comprising:
a plastic part formed of a plastic material,
a mandrel integral with and extending transversely from said plastic part,
a flexible component integral with and disposed outwardly of said mandrel,
said flexible component including arms having a length extending transversely to said plastic part, wherein said arms are contractible in said length, and
said flexible component including an intermediate section extending between said arms and outwardly of said mandrel and having a width extending parallel to said plastic part, wherein said intermediate section is expandable in said width.

2. A re-useable integrated plastic part and fastener as set forth in claim 1 wherein said arms contract in said length and said intermediate section expands in said width simultaneously when said flexible component engages the support member and an insertion force is applied to said plastic part.

3. A re-useable integrated plastic part and fastener as set forth in claim 1 wherein said mandrel includes a base extending transversely from said plastic part, said base has a base width extending parallel to said plastic part, and said width of said intermediate section is less than said base width.

4. A re-useable integrated plastic part and fastener as set forth in claim 3 wherein said mandrel includes at least one shaft extending transversely from said base, said shafts have a combined width extending parallel to said base width, and said combined width is less than said base width.

5. A re-useable integrated plastic part and fastener as set forth in claim 4 wherein said shafts present a concave surface for engaging said flexible component as said arms contract in said length and said intermediate section expands in said width.

6. A re-useable integrated plastic part and fastener as set forth in claim 4 wherein said shafts present a ledge facing said plastic part so that said mandrel defines a channel between said ledge and said base for receiving said flexible component as said arms contract in said length and said intermediate section expands in said width.

7. A re-useable integrated plastic part and fastener as set forth in claim 4 wherein said mandrel includes a pair of said shafts spaced from one another and each extending from said base to a shaft head and defining a keyhole slot therebetween and open at said shaft heads.

8. A re-useable integrated plastic part and fastener as set forth in claim 1 wherein said arms of said flexible component include a plurality of hinge points each having a thickness less than the thickness of the remaining portions of said arms allowing said arms to bend at said hinge points and contract in said length.

9. A re-useable integrated plastic part and fastener as set forth in claim 1 wherein said flexible component includes a rivet defining a groove facing outwardly from said mandrel and disposed between each of said arms and said intermediate section for engaging said mandrel as said arms contract in said length and said intermediate section expands in said width.

10. A re-useable integrated plastic part and fastener as set forth in claim 9 wherein said arms and said intermediate section and said rivets each have thickness, and said thickness of said arms and said intermediate section is less than said thickness of said rivets.

11. A re-useable integrated plastic part and fastener as set forth in claim 9 wherein said mandrel includes a base extending transversely from said plastic part, said base has a base width extending parallel to said plastic part, said width of said intermediate section is less than said base width, said grooves of said rivets are spaced from one another by a groove width, and said groove width is less than said base width.

12. A re-useable integrated plastic part and fastener as set forth in claim 1 wherein said intermediate section expands from an uninstalled intermediate width to an installed intermediate width as said arms contract from an uninstalled arm length to an installed arm length, said installed intermediate width being greater than said uninstalled intermediate width, and said installed arm length being than less said uninstalled arm length.

13. A re-useable integrated plastic part and fastener as set forth in claim 1 including a truss member interconnecting said mandrel and said intermediate section for supporting said intermediate section as said intermediate section expands in said width.

14. A re-useable integrated plastic part and fastener as set forth in claim 1 wherein said plastic part and said mandrel and said flexible component are homogenous and each formed of said plastic material.

15. A re-useable integrated plastic part and fastener as set forth in claim 14 wherein said plastic material is selected from the group consisting of: polypropylene, nylon, and polycarbonate-acrylonitrile butadiene styrene (PC-ABS).
